(19) United States
(12) Patent Application Publication
(10) Pub. No.: US 2013/0277530 A1
(43) Pub. Date: Oct. 24, 2013

(54) Portable stand for a tablet personal computer

(71) Applicant: KUNSHAN AIGENAOMI DIGITAL TECHNOLOGY CO., LTD, Suzhou (CN)

(72) Inventor: Lim Seong WONG, Suzhou (CN)

(73) Assignee: Kunshan Aigenaomi Digital Technology co., LTD, Suzhou (CN)

(21) Appl. No.: 13/669,372

(22) Filed: Nov. 5, 2012

(30) Foreign Application Priority Data
Apr. 18, 2012 (CN) 201210113920.5

(51) Int. Cl. F16M 11/00

(52) U.S. Cl. 248/687; 248/688

(57) ABSTRACT

A portable stand for a tablet personal computer (PC), adapted for the auxiliary use of the tablet PC, includes a rotation back panel, two flexible stands, a surface cover, and a handle. The rotation back panel is movably connected with the handle via a rotating disk. The surface cover is fixedly connected with the rotation back panel by the buckling method. The two flexible stands are located between the surface cover and the rotation back panel. The portable stand for a tablet PC of the present invention has simple and firm structure, complete function, convenient production and assembly, and low cost of to production, and is operated easily and flexibly. It can be applied to the tablet PCs with various types and specifications, instead of being limited to handheld use. It can be absorbed to the metal surface via the magnet, thus the tablet PC has more diversified using way.

### BACKGROUND OF THE PRESENT INVENTION

1. Field of Invention

The present invention relates to a stand for a tablet personal computer, and more particularly to a portable stand for a tablet personal computer.

2. Description of Related Arts

With the rapid development of the computer technology, the portable computer with convenient carrying and complete function has been more and more in people's good graces. The tablet personal computer (PC), as a small portable PC, due to novel appearance, light weight, small volume and many other advantages, has been more and more widely used. In general, while using a tablet PC, the tablet PC is directly placed on the desk or in the hands of the user, which has single use. Accordingly, the hands will touch the screen and the back panel of the tablet PC. As a result, the computer gets easily dirty.

Currently, there are some simple stands for tablet PCs on the market. They generally only play a supporting role, which is obviously inflexible. The invention with Patent Application No. 201110162852 discloses a stand for a tablet PC. Compared with the traditional stand, the stand in the above-mentioned invention has improved structure and function, and is convenient to be used. However, it has some disadvantages as follows. It is not able to adapted for the tablet PCs with different sizes. When it is used to fix the tablet PC, the fixation method is relatively simple and not perfect enough. While being used, it can not achieve the goal of 360-degree flexible rotation, and very ideally humanized effect. Furthermore, it has more complex fabrication and installation.

### SUMMARY OF THE PRESENT INVENTION

To overcome the technical problems of the prior art, the present invention provides a portable stand for a tablet personal computer (PC), which is capable of locking the tablet PC by the hook-shaped structures of the flexible stands, and has the rotation back panel with 360-degree free rotation function. Simultaneously, the portable stand for a tablet PC provided by the present invention further includes a handle. On the one hand, the tablet PC can be held to use via the handle by hand, and on the other hand, the handle acts as the stand and plays the supporting role when the tablet PC is placed on the desk. The flexibility and convenient adjustment of the portable stand for a tablet PC provided by the present invention bring great pleasure to the user.

In order to accomplish the above object, the present invention provides a technical solution as follows.

A portable stand for a tablet personal computer (PC), adapted for an auxiliary use of the tablet PC, comprises a rotation back panel, two flexible stands, a surface cover, and a handle, wherein the rotation back panel is movably connected with the handle via a rotating disk, the surface cover is fixedly connected with the rotation back panel by a buckling method, the two flexible stands are located between the surface cover and the rotation back panel, and the two flexible stands are respectively connected with two gears via a spring.

Furthermore, two active toothed belts are respectively provided on the two flexible stands; two passive toothed belts, which are respectively corresponding to the active toothed belts on the two flexible stands, are provided on a surface at which the surface cover is buckled with the rotation back panel; and the active toothed belts are respectively engaged with the passive toothed belts by two limit switches installed between the two flexible stands and the rotation back panel.

Furthermore, two switch mounting holes for installing the limit switches are provided on the surface at which the surface cover is buckled with the rotation back panel, and the positions of the switch mounting holes are corresponding to the active toothed belts.

Furthermore, a cylindrical projection is provided at a center of the other surface of the rotation back panel, an outer surface of the cylindrical projection is gear-shaped, an interior of the rotating disk is buckled within an interior of the cylindrical projection, an exterior of the rotating disk covers the cylindrical projection, and the rotating disk is capable of rotating around the cylindrical projection.

Furthermore, two limit holes, two racks and a spring locking column are provided at one end of each of the two flexible stands, the two flexible stands are installed on the rotating back panel upside down, the spring locking columns of the two flexible stands are connected with each other by a spring, and the two racks of one of the two flexible stands are respectively connected with the two racks of the other of the two flexible stands by the gears.

Furthermore, four limit columns corresponding to the limit holes on the two flexible stands, and two gear fixing columns for respectively maintaining constant positions of the two gears relative to the rotating back panel are provided on the rotating back panel.

Furthermore, two fixing toothed parts engaged with the handle are respectively provided at two ends of a centerline of the rotating disk, and two active toothed parts matching with the fixing toothed parts are respectively provided at two ends of the handle.

Furthermore, four symmetrical anti-slip pads are respectively provided at four corners of the other surface of the surface cover.

Furthermore, a screw hole is provided at the rotating disk, and a tightness between the rotating disk and the cylindrical projection is adjusted by a top bead screw screwed within the screw hole.

Furthermore, a cylindrical magnet is provided between the cylindrical projection and the rotating disk.

Furthermore, the other end of each of the two flexible stands is a hook-shaped structure, and a long hole for stretching each of the two flexible stands is provided on the hook-shaped structure.

The beneficial effects of the present invention are as follows. The present invention has simple and firm structure, complete function, convenient production and assembly, and low cost of production, and is operated easily and flexibly. It can be applied to the tablet PCs with various types and specifications, instead of being limited to handheld use. It can be absorbed to the metal surface by the magnet, thus the tablet PC has more diversified using way.

### BRIEF DESCRIPTION OF THE DRAWINGS

FIG. 1 is a three-dimensional structure diagram of a portable stand for a tablet personal computer (PC) according to a preferred embodiment of the present invention.

FIG. 2 is a front view of the portable stand for a tablet personal computer (PC) according to the preferred embodiment of the present invention.

FIG. 3 is a front structure diagram of a rotation back panel.

FIG. 4 is a rear structure diagram of the rotation back panel.

FIG. 5 is an assembled structure diagram of a first flexible stand, a second flexible stand and the rotation back panel.

FIG. 6 is a structural diagram of a surface cover.

FIG. 7 is a structural diagram of a rotating disk.

FIG. 8 is a structural diagram of a handle.

FIG. 9 is a structural diagram of a limit switch.

### DETAILED DESCRIPTION OF THE PREFERRED EMBODIMENT

The preferred embodiment of the present invention is further explained in detail with the accompanying drawings, so that the advantages and features of the present invention can be more easily understood by those skilled in the art, thus the scope of protection of the present invention will be made more clear definition.

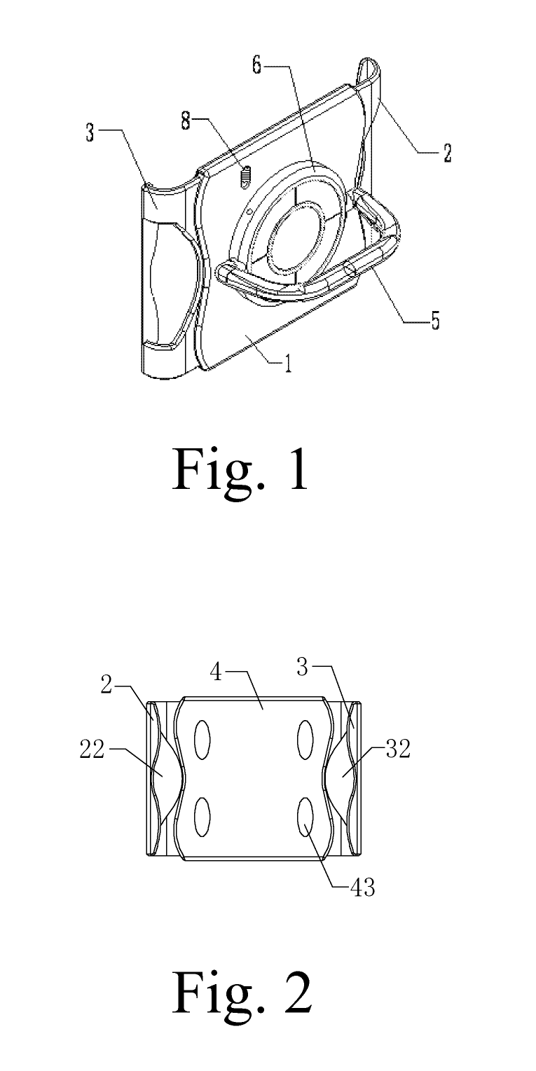

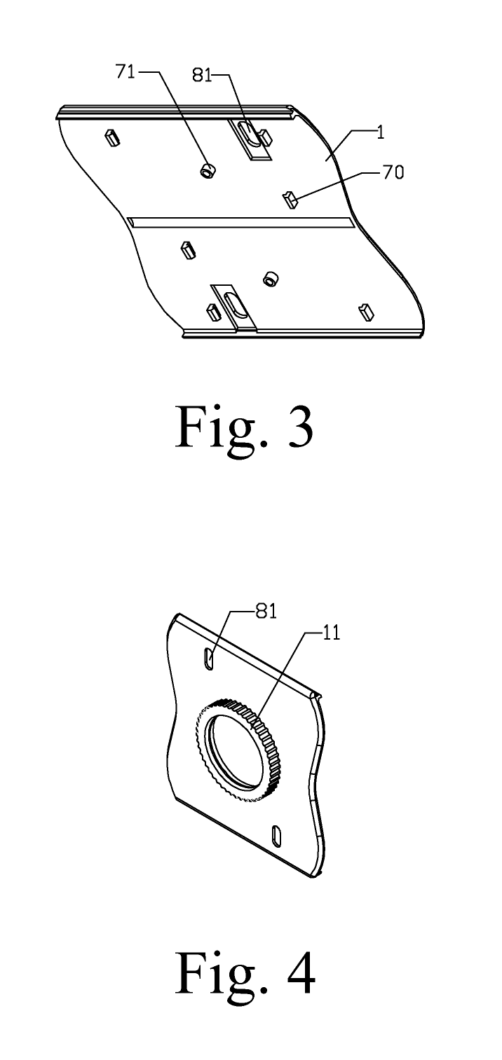

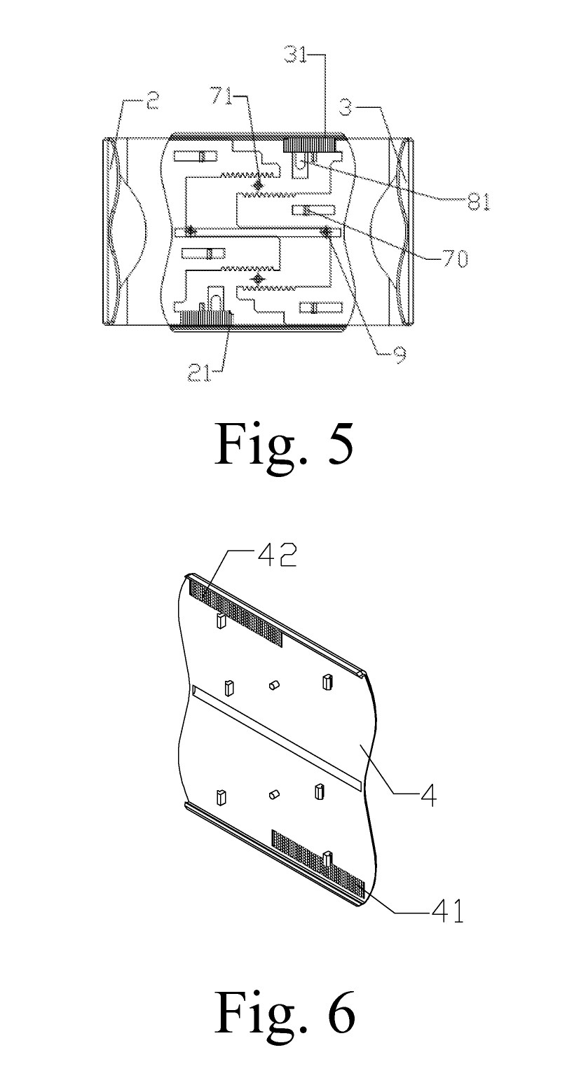

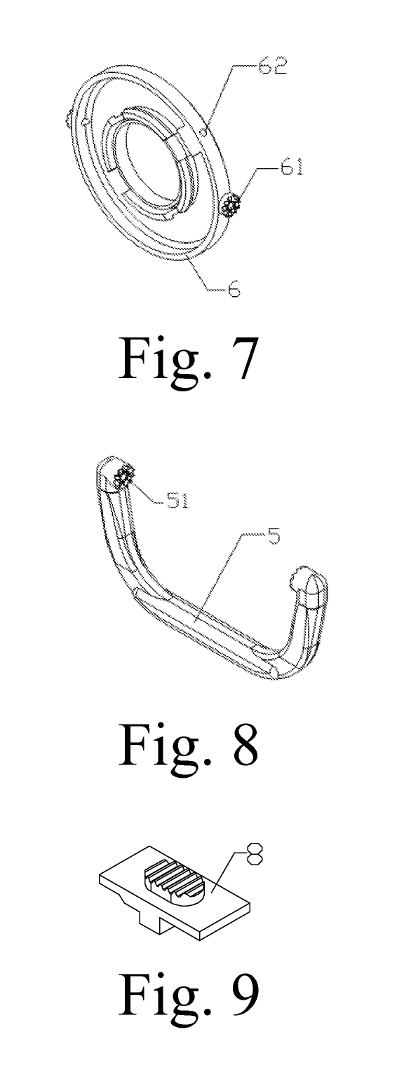

Referring to FIGS. 1 to 9 of the drawings, a portable stand for a tablet personal computer (PC) is adapted for the auxiliary use of the tablet PC. The portable stand comprises a rotation back panel 1, a first flexible stand 2, a second flexible stand 3, a surface cover 4 and a handle 5. The rotation back panel 1 is movably connected with the handle 5 via a rotating disk 6. The surface cover 4 is fastened with the rotation back panel 1 by the buckling method. The first flexible stand 2 and the second flexible stand 3 are placed between the surface cover 4 and the rotation back panel 1, and are respectively connected with two gears 7 via a spring. A first active toothed belt 21 is provided on the first flexible stand 2. A second active toothed belt 31 is provided on the second flexible stand 3. A first passive toothed belt 41 and a second passive toothed belt 42, which are respectively corresponding to the first active toothed belt 21 and the second active toothed belt 31, are provided on a surface at which the surface cover 4 is buckled with the rotation back panel 1. The two active toothed belts are respectively engaged with the two passive toothed belts by two limit switches 8 which are respectively installed between the flexible stands and the rotation back panel 1. Two switch mounting holes 81, for respectively installing the limit switches 8, are provided at the surface at which the surface cover 4 is buckled with the rotation back panel 1. The positions of the switch mounting holes 81 are corresponding to the passive toothed belts. A cylindrical projection 11 is provided at a center of the other surface of the rotation back panel 1. An outer surface of the cylindrical projection 11 is gear-shaped. An interior of the rotating disk 6 is buckled within an interior of the cylindrical projection 11. An exterior of the rotating disk 6 covers the cylindrical projection 11. The rotating disk 6 is capable of rotating around the cylindrical projection 11. Two limit holes, two racks and a spring locking column 9 are provided at one end of one of the first flexible stand 2 and the second flexible stand 3. The two flexible stands are installed on the rotating back panel 1 upside down. The spring locking columns of the two flexible stands are connected with each other by a spring. The two racks of the first flexible stand 2 are respectively connected with the two racks of the second flexible stand 3 by the gears. Four limit columns 70 corresponding to the limit holes on the flexible stands, and two gear fixing columns 71 for respectively maintaining constant positions of the two gears 7 relative to the rotating back panel 1 are provided on the rotating back panel 1. Two fixing toothed parts 61 engaged with the handle are respectively provided at two ends of a centerline of the rotating disk 6. Two active toothed parts 51 matching with the fixing toothed parts 61 are respectively provided at two ends of the handle 5. Four symmetrical anti-slip pads 43 are respectively provided at four corners of the other surface of the surface cover 4. A screw hole 62 is provided at the rotating disk 6, and the tightness between the rotating disk 6 and the cylindrical projection 11 is adjusted by a top bead screw screwed within the screw hole. A cylindrical magnet is provided between the cylindrical projection 11 and the rotating disk 6. The other end of each of the first flexible stand 2 and the second flexible stand 3 is a hook-shaped structure. A first long hole 22 and a second long hole 32 for stretching the flexible stands are respectively provided on the hook-shaped structures of the first flexible stand 2 and the second flexible stand 3.

The above-mentioned description is only one of the specific embodiments of the present invention, but the scope of protection of the present invention is not limited thereto. In the technical scope disclosed by the present invention, the modifications or replacements without creative labor thought by one skilled in the art should be covered within the scope of protection of the present invention. Therefore, the scope of protection of the present invention should be defined by claims.

1-11. (canceled)

12. A portable stand for a tablet personal computer (PC), adapted for an auxiliary use of the tablet PC, comprising:
a rotation back panel, two flexible stands, a surface cover, and a handle, wherein the rotation back panel is movably connected with the handle via a rotating disk, the surface cover is fixedly connected with the rotation back panel by a buckling method, the two flexible stands are located between the surface cover and the rotation back panel, and the two flexible stands are respectively connected with two gears via a spring.

13. The portable stand, as recited in claim 12, wherein two active toothed belts are respectively provided on the two flexible stands; two passive toothed belts, which are respectively corresponding to the active toothed belts on the two flexible stands, are provided on a surface at which the surface cover is buckled with the rotation back panel; and the active toothed belts are respectively engaged with the passive toothed belts by two limit switches respectively installed between the two flexible stands and the rotation back panel.

14. The portable stand, as recited in claim 13, wherein two switch mounting holes for respectively installing the limit switches are provided on the surface at which the surface cover is buckled with the rotation back panel, and positions of the switch mounting holes are corresponding to the active toothed belts.

15. The portable stand, as recited in claim 13, wherein a cylindrical projection is provided at a center of the other surface of the rotation back panel, an outer surface of the cylindrical projection is gear-shaped, an interior of the rotating disk is buckled within an interior of the cylindrical projection, an exterior of the rotating disk covers the cylindrical projection, and the rotating disk is capable of rotating around the cylindrical projection.

16. The portable stand, as recited in claim 14, wherein a cylindrical projection is provided at a center of the other surface of the rotation back panel, an outer surface of the cylindrical projection is gear-shaped, an interior of the rotating disk is buckled within an interior of the cylindrical projection, an exterior of the rotating disk covers the cylindrical projection, and the rotating disk is capable of rotating around the cylindrical projection.

17. The portable stand, as recited in claim 12, wherein two limit holes, two racks and a spring locking column are provided at one end of each of the two flexible stands, the two flexible stands are installed on the rotating back panel upside down, the spring locking columns of the two flexible stands are connected with each other by the spring, and the two racks of one of the two flexible stands are respectively connected with the two racks of the other of the two flexible stands by the gears.

18. The portable stand, as recited in claim 13, wherein two limit holes, two racks and a spring locking column are provided at one end of each of the two flexible stands, the two flexible stands are installed on the rotating back panel upside down, the spring locking columns of the two flexible stands are connected with each other by the spring, and the two racks of one of the two flexible stands are respectively connected with the two racks of the other of the two flexible stands by the gears.

19. The portable stand, as recited in claim 16, wherein two limit holes, two racks and a spring locking column are provided at one end of each of the two flexible stands, the two flexible stands are installed on the rotating back panel upside down, the spring locking columns of the two flexible stands are connected with each other by the spring, and the two racks of one of the two flexible stands are respectively connected with the two racks of the other of the two flexible stands by the gears.

20. The portable stand, as recited in claim 17, wherein four limit columns corresponding to the limit holes on the two flexible stands, and two gear fixing columns for respectively maintaining constant positions of the two gears relative to the rotating back panel are provided on the rotating back panel.

21. The portable stand, as recited in claim 19, wherein four limit columns corresponding to the limit holes on the two flexible stands, and two gear fixing columns for respectively maintaining constant positions of the two gears relative to the rotating back panel are provided on the rotating back panel.

22. The portable stand, as recited in claim 12, wherein two fixing toothed parts engaged with the handle are respectively provided at two ends of a centerline of the rotating disk, and two active toothed parts matching with the fixing toothed parts are respectively provided at two ends of the handle.

23. The portable stand, as recited in claim 21, wherein two fixing toothed parts engaged with the handle are respectively provided at two ends of a centerline of the rotating disk, and two active toothed parts matching with the fixing toothed parts are respectively provided at two ends of the handle.

24. The portable stand, as recited in claim 12, wherein four symmetrical anti-slip pads are respectively provided at four corners of the other surface of the surface cover.

25. The portable stand, as recited in claim 23, wherein four symmetrical anti-slip pads are respectively provided at four corners of the other surface of the surface cover.

26. The portable stand, as recited in claim 15, wherein a screw hole is provided at the rotating disk, and a tightness between the rotating disk and the cylindrical projection is adjusted by a top bead screw screwed within the screw hole.

27. The portable stand, as recited in claim 23, wherein a screw hole is provided at the rotating disk, and a tightness between the rotating disk and the cylindrical projection is adjusted by a top bead screw screwed within the screw hole.

28. The portable stand, as recited in claim 15, wherein a cylindrical magnet is provided between the cylindrical projection and the rotating disk.

29. The portable stand, as recited in claim 23, wherein a cylindrical magnet is provided between the cylindrical projection and the rotating disk.

30. The portable stand, as recited in claim 12, wherein the other end of each of the two flexible stands is a hook-shaped structure, and a long hole for stretching each of the two flexible stands is provided on the hook-shaped structure.

31. The portable stand, as recited in claim 29, wherein the other end of each of the two flexible stands is a hook-shaped structure, and a long hole for stretching each of the two flexible stands is provided on the hook-shaped structure.
